(19) United States
(12) Patent Application Publication
(10) Pub. No.: US 2014/0140532 A1
(43) Pub. Date: May 22, 2014

(54) SPEAKER BOX STRUCTURE

(71) Applicant: Ching-Po Wang, Taipei (TW)

(72) Inventor: Ching-Po Wang, Taipei (TW)

(21) Appl. No.: 13/682,250

(22) Filed: Nov. 20, 2012

(51) Int. Cl. B60R 11/02

(52) U.S. Cl. CPC B60R 11/02
USPC 381/86

(57) ABSTRACT

A speaker box structure is configured for mounting to a motorcycle between a front wheel and an engine thereof, and includes a tubular bottom section internally having at least one reflex tube oriented to a ground surface; two tubular bent sections respectively connected to two ends of the tubular bottom section; two tubular connection sections respectively connected to ends of the tubular bent sections opposite to the tubular bottom section; and at least two speaker units respectively connected to the tops of the two tubular connection sections. And, the reflex tube is sequentially communicable with the tubular bent sections and tubular connection sections. With these arrangements, music of improved tone quality can be output via the speaker box structure.

### FIELD OF THE INVENTION

The present invention relates to a speaker box structure, more particularly, a speaker box structure configured for mounting on a motorcycle, such as a cruiser motorcycle.

### BACKGROUND OF THE INVENTION

When driving a car during a long-distance travel, the driver can listen to music or broadcast through a car stereo to prevent from falling into a trance and so that the driving is not boring or irritating. However, unlike cars, currently most of the available motorcycles are not equipped with a speaker system. So we believe, good speakers or a stereo system mounted on a motorcycle can provide a motorcycle rider with wonderful riding experience.

Some motorcycle riders would wear headphones connected to a music player to enjoy the riding. However, according to the design of headphones, a rider will be unable to hear nearby car horns or other warning sounds at all once a rider wears the headphones. Therefore, it is very dangerous for a motorcycle rider who listens to music through headphones during riding.

There are also motorcycle riders who listen to music while riding by mounting mini speakers or portable speakers on handlebars of the motorcycle and connecting them to a music player. However, the tone quality of the music output from the mini speakers or portable speakers is much inferior compared to a home stereo system. That is, the mini speakers or the portable speakers are structured for a user to conveniently carry about them and hardly enable the music player to play music with good tone quality. In addition, the mini speakers or portable speakers can usually produce a relatively low sound volume. Therefore, the output music is almost covered by hissing sounds when the motorcycle moves at high speed.

It is therefore desirable to develop a speaker box structure that allows a motorcycle rider to listen to music of good tone quality while riding without the risk of causing an accident due to not hearing nearby car horns or warning sounds.

### SUMMARY OF THE INVENTION

A primary object of the present invention is to provide a speaker box structure that can be additionally mounted to a motorcycle.

Another object of the present invention is to provide a speaker box structure that allows a rider to listen to music while riding a motorcycle without the risk of causing an accident due to not hearing nearby car horns or warning sounds.

A further object of the present invention is to provide a speaker box structure that is able to output music with improved tone quality.

To achieve the above and other objects, the speaker box structure according to the present invention is configured for mounting to a motorcycle between a front wheel and an engine thereof, and includes a tubular bottom section, two tubular bent sections, two tubular connection sections, and at least two speaker units. The tubular bottom section has a first end and an opposite second end, and at least one reflex tube; and the reflex tube is located in the tubular bottom section between the first end and the second end and orients to a ground surface. The two tubular bent sections respectively have a first end and a second end; and the first ends of the two tubular bent sections are respectively connected to the first end and the second end of the tubular bottom section. The two tubular connection sections respectively have a first end and a second end; and the first ends of the two tubular connection sections are respectively connected to the second ends of the two tubular bent sections. The at least two speaker units are respectively connected to the second ends of the two tubular connection sections. The reflex tube is sequentially communicable with the tubular bent sections and tubular connection sections.

According to an operable embodiment of the present invention, the tubular bottom section has two reflex tubes located therein and is further internally provided with a separating element to isolate the two reflex tubes from each other.

According to an operable embodiment of the present invention, the tubular bottom section, the tubular bent sections and the tubular connection sections are made of plastic tubes, such as polyvinylchloride (PVC) tubes, acrylonitrile butadiene styrene (ABS) tubes, polyethylene (PE) tubes, fibre-reinforced plastic(FRP) tubes, or poly(methyl methacrylate) tubes (i.e. PMMA tubes).

According to an operable embodiment of the present invention, the tubular connection sections respectively include a tubular redirecting section located at the second ends of the tubular connection sections, and the speaker units are respectively connected to the two tubular redirecting sections.

According to an operable embodiment of the present invention, the tubular connection sections respectively include a tubular redirecting section located at the first ends of the tubular connection sections and the tubular redirecting sections respectively connect to the second ends of the tubular bent sections.

According to an operable embodiment of the present invention, the speaker units can be full-range speaker units, tweeters, mid-range speaker units, woofers, or any combination thereof

According to an operable embodiment of the present invention, there are four speaker units, and the second ends of the two tubular connection sections respectively have two of the four speaker units connected thereto.

According to an operable embodiment of the present invention, the tubular bottom section, the tubular bent sections and the tubular connection sections are assembled together to give the whole speaker box structure a U-shaped or a V-shaped configuration.

According to an operable embodiment of the present invention, the tubular bottom section, the tubular bent sections and the tubular connection sections are integrally formed with one another.

With the above arrangements, the speaker box structure of the present invention allows a rider to listen to music with improved tone quality while riding a motorcycle and without any risk due to not hearing nearby car horns or warning sounds. In addition, the speaker box structure of the present invention has simple structure to save a lot of manufacturing cost and shorten the assembling time therefor.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a speaker box structure according to a first embodiment of the present invention;

FIG. 2 is a side view showing the speaker box structure of FIG. 1 mounted to a motorcycle;

FIG. 3 is a front view of FIG. 2;

FIG. 4 is an exploded perspective view of a speaker box structure according to a second embodiment of the present invention;

FIG. 5 is a side view showing the speaker box structure of FIG. 4 mounted to a motorcycle;

FIG. 6 is a front view of FIG. 5;

FIG. 7 is an exploded perspective view of a speaker box structure according to a third embodiment of the present invention;

FIG. 8 is a side view showing the speaker box structure of FIG. 7 mounted to a motorcycle; and

FIG. 9 is a front view of FIG. 8.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

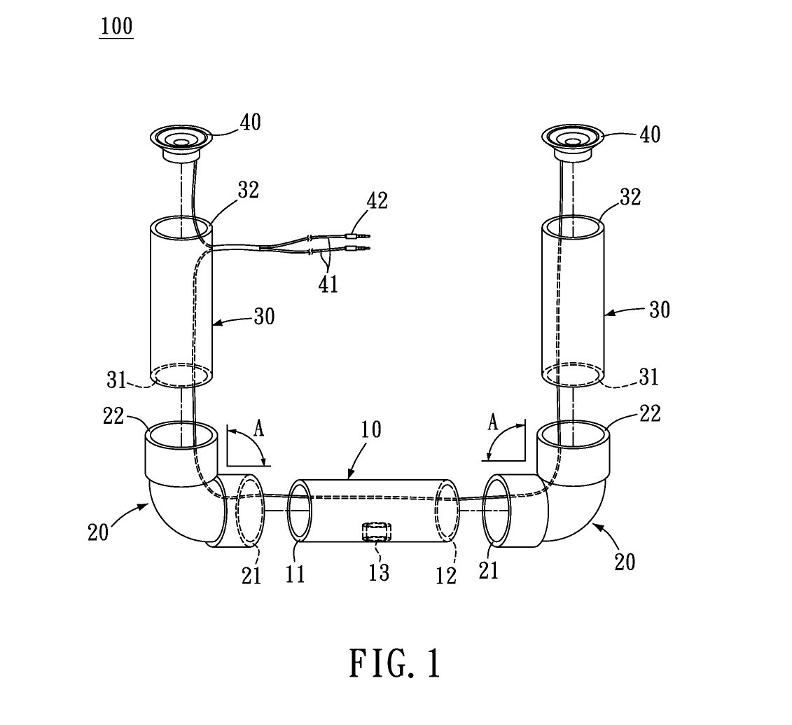

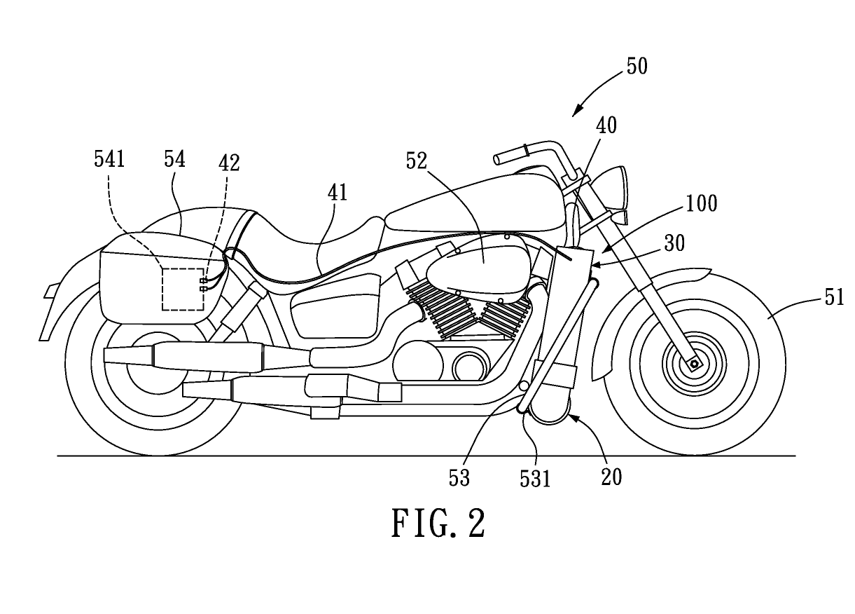

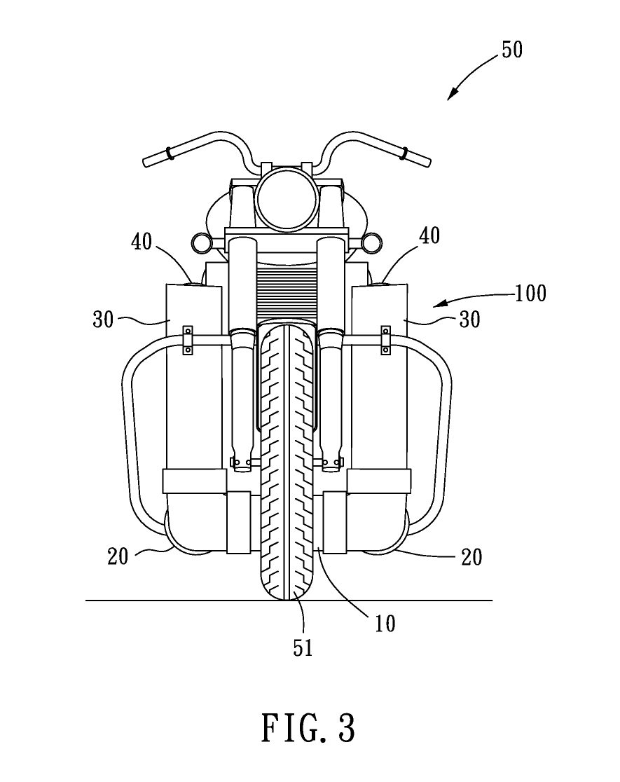

Please refer to FIG. 1 that is an exploded perspective view of a speaker box structure 100 according to a first embodiment of the present invention, and to FIGS. 2 and 3 that are side and front views, respectively, showing the speaker box structure 100 mounted on a motorcycle 50.

The speaker box structure 100 is configured for mounting between a front wheel 51 and an engine 52 of the motorcycle 50. More specifically, the speaker box structure 100 is supported on a protective bar 53 of the motorcycle 50. The protective bar 53 can be a tilt-prevention bumper or any other additionally mounted supporting bar. With this design, the speaker box structure 100 can be accommodated in a space between the front wheel 51 and the engine 52 without protruding too much from the motorcycle 50.

The speaker box structure 100 includes a tubular bottom section 10, two tubular bent sections 20, two tubular connection sections 30, and at least two speaker units 40.

As can be seen in FIG. 1, the tubular bottom section 10 has a first end 11, an opposite second end 12 and at least one reflex tube 13. The reflex tube 13 is located in the tubular bottom section 10 between the first end 11 and the second end 12 and orients a ground surface.

The tubular bent sections 20 respectively have a first end 21 and a second end 22. The first ends 21 of the two tubular bent sections 20 are respectively connected to the first end 11 and the second end 12 of the tubular bottom section 10 by means of hooking, locking, snap-fitting or the like. In the illustrated first embodiment, the tubular bent sections 20 respectively contain an angle A, which can be, but not limited to, about 90 degrees. A user (i.e. a motorcycle rider) may adjust the tubular bent sections 20 to different angles according to a configuration or appearance of the motorcycle 50, so that the speaker box structure 100 can be mounted to the motorcycle 50 in an optimal manner.

The tubular connection sections 30 respectively have a first end 31 and an opposite second end 32. The first ends 31 of the two tubular connection sections 30 are connected to the second ends 22 of the two tubular bent sections 20 by means of hooking, locking, snap-fitting or the like. In the illustrated first embodiment, the tubular connection sections 30 are straight tubes.

The speaker units 40 are respectively connected to the second ends 32 of the two tubular connection sections 30 by means of hooking, locking, snap-fitting or the like. The speaker units 40 respectively have a plurality of signal cables 41, which are arranged in the tubular connection sections 30, the tubular bent sections 20 and the tubular bottom section 10 to extend to an outer side of the speaker box structure 100 from one of the tubular connection sections 30. Each of the signal cables 41 is provided at a distal end with a connecting terminal 42 for connecting to an amplifier 541. The amplifier 541 can be arranged in a saddle box 54 on the motorcycle 50, as shown in FIG. 2. The speaker units 40 can be full-range speakers, tweeters, mid-range speakers, woofers or any combination thereof. The rider may change the tone quality by mounting different speaker units 40.

The tubular bottom section 10, the tubular bent sections 20 and the tubular connection sections 30 shown in FIGS. 1 and 3 can be made of plastic tubes, such as polyvinylchloride (PVC) tubes, acrylonitrile butadiene styrene (ABS) tubes, polyethylene (PE) tubes, fibre-reinforced plastic(FRP) tubes, or poly(methyl methacrylate) tubes (i.e. PMMA tubes). The rider may select plastic tubes with different lengths and diameters according to pratical requirement. In other words, the rider can change the quality of sound output by the speaker box structure 100 by changing the lengths and the diameters of the plastic tubes for forming the tubular bottom section 10, the tubular bent sections 20 and the tubular connection sections 30. In addition, the assembled tubular bottom section 10, tubular bent sections 20 and tubular connection sections 30 give the whole speaker box structure 100 a substantially U-shaped configuration. With the reflex tube 13, the speaker box structure 100 forms a bass reflex system, and the reflex tube 13 is sequentially communicable with the tubular bent sections 20 and the tubular connection sections 30. As the reflex tube 13 orients to the ground surface, so that the enhanced low frequency sound will be reflected by the ground surface and then reaches the rider.

Please refer to FIGS. 2 and 3 again. To mount the speaker box structure 100 according to the present invention, the user can first select the lengths, angles and shapes of the tubular bottom section 10, the tubular bent sections 20 and the tubular connection sections 30 according to the space size between the front wheel 51 and the engine 52 as well as the shape and position of the protective bar 53. Then, the user may fixedly connect the tubular connection sections 30 of the speaker box structure 100 to the protective bar 53 by locking, tying, hooking or the like, as shown in FIG. 2. In the illustrated first embodiment, the tubular connection sections 30 are locked to the protective bar 53 via a plurality of fastening element 531, which can be, for example, fixtures, hooks, C-rings, screws, rivets and the like. Thereafter, the signal cables 41 are extended along a path specified by the user. For instance, in the illustrated first embodiment, the signal cables 41 are extended along the fuel tank and the saddle into the saddle box 54, and are connected at the connecting terminals 42 to the amplifier 541. With the above arrangements, the rider can listen to music while riding without the risk of not hearing nearby car horns or warning sounds.

In brief, the speaker box structure 100 of the present invention can be configured and mounted according to the motorcycle appearance, such as the space size between the front wheel and the engine, the shape and position of the protective bar and the like, and can therefore be additionally mounted on different types of motorcycles, such as cruiser motorcycles. Further, the speaker box structure 100 of the present invention also allows the user to adjust the sizes and angles of the tubular bottom section 10, the tubular bent sections 20 and the tubular connection sections 30 and to select different types of speaker units 40 according to the user's actual need. Because the tubular bottom section 10, the tubular bent sections 20 and the tubular connection sections 30 have simple structure and are made of plastic tubes that are easily to get, the speaker box structure 100 of the present invention can be manufactured at effective way to reduce the cost and assembling time. Moreover, while not shown in drawings, the tubular bottom section 10, the tubular bent sections 20 and the tubular connection sections 30 can be otherwise integrally formed with one another.

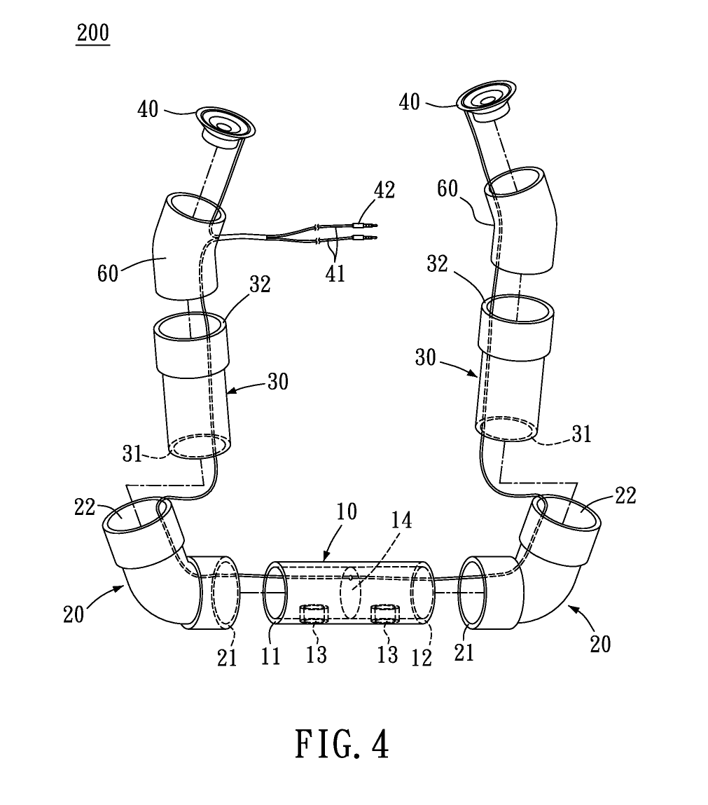

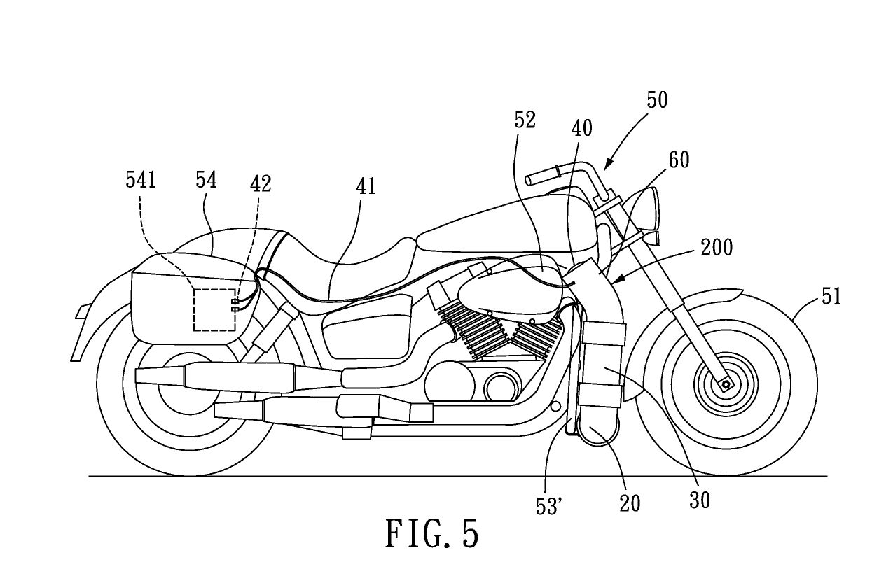

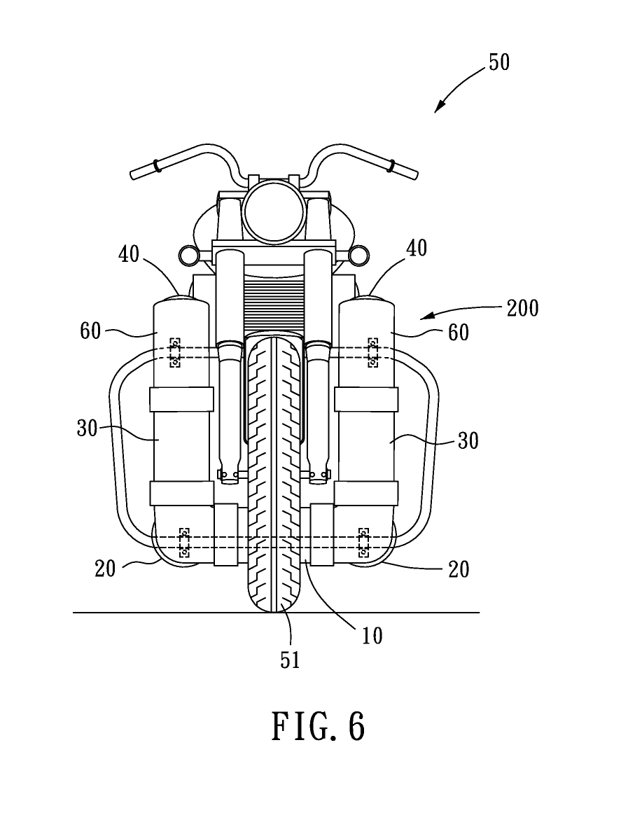

Please refer to FIGS. 4 to 6, in which FIG. 4 is an exploded perspective view of a speaker box structure 200 according to a second embodiment of the present invention, and FIGS. 5 and 6 are side and front views, respectively, showing the speaker box structure 200 mounted on a motorcycle 50.

The speaker box structure 200 in the second embodiment is generally structurally similar to the speaker box structure 100 in the first embodiment, except that, in the second embodiment, the tubular bottom section 10 has two reflex tubes 13 and a separating element 14 located in and the two tubular connection sections 30 further include a tubular redirecting section 60 each. The separating element 14 can be, for example, a separating plate provided in the tubular bottom section 10 to isolate the two reflex tubes 13 from each other. As the reflex tube 13 orients to the ground surface, so that the enhanced low frequency sound will be reflected by the ground surface and then reaches the rider. The tubular redirecting sections 60 are connected at their lower ends to the second ends 32 of the two tubular connection sections 30, and the speaker units 40 are connected to upper ends of the tubular redirecting sections 60. With these arrangements, the speaker box structure 200 can be assembled and mounted to the motorcycle 50 according to the configuration and appearance thereof while allowing effective change of the directions to which the speaker units 40 are directed. The tubular redirecting sections 60 can be integrally formed with the tubular connection sections 30 or be connected thereto by means of hooking, locking, snap-fitting or the like.

As can be seen in FIG. 6, with the tubular redirecting sections 60, the speaker units 40 can be more accurately directed to the rider's face, so that the music output via the speaker box structure 200 can be directly transmitted to the rider's ears.

In brief, the speaker box structure 200 of the present invention can be configured and mounted according to the motorcycle appearance, such as the space size between the front wheel and the engine, the shape and position of the protective bar 53′ and the like, and therefore can be additionally mounted on different types of cruiser motorcycles. Further, the speaker box structure 200 of the present invention also allows the user to adjust the sizes and angles of the tubular bottom section 10, the tubular bent sections 20, the tubular connection sections 30 and the tubular redirecting sections 60 and to select different types of speaker units 40 according to the rider's actual need. Because the tubular bottom section 10, the tubular bent sections 20, the tubular connection sections 30 and the tubular redirecting sections 60 have simple structure and are made of plastic tubes that are easily to get, the speaker box structure 200 of the present invention can be manufactured at effective way to reduce the cost and assembling time.

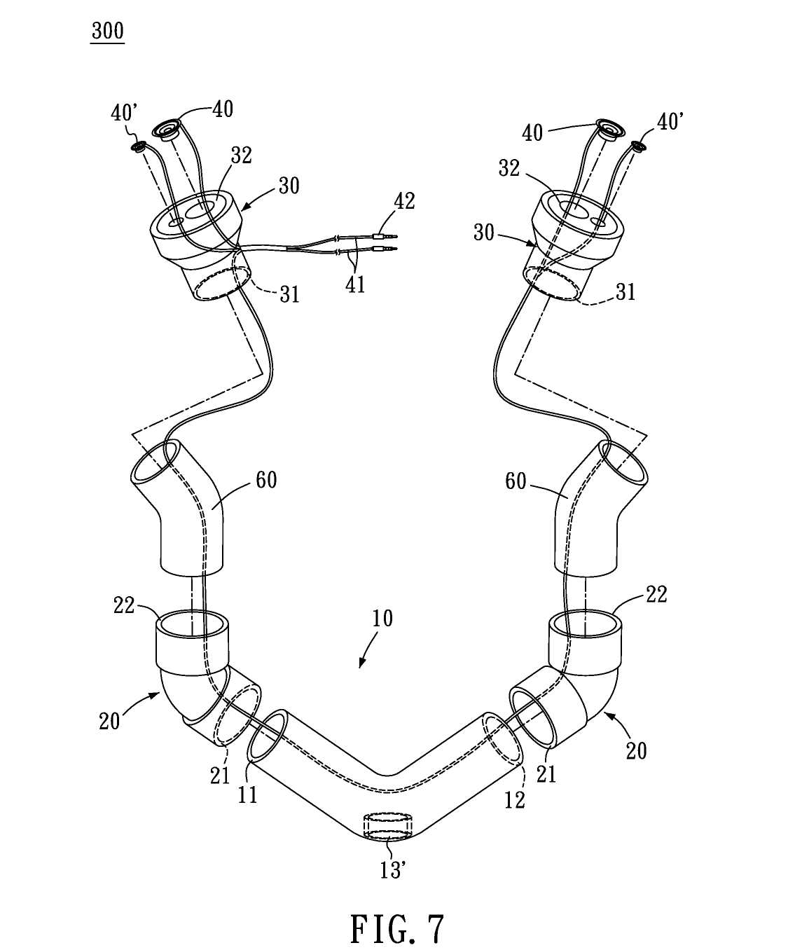

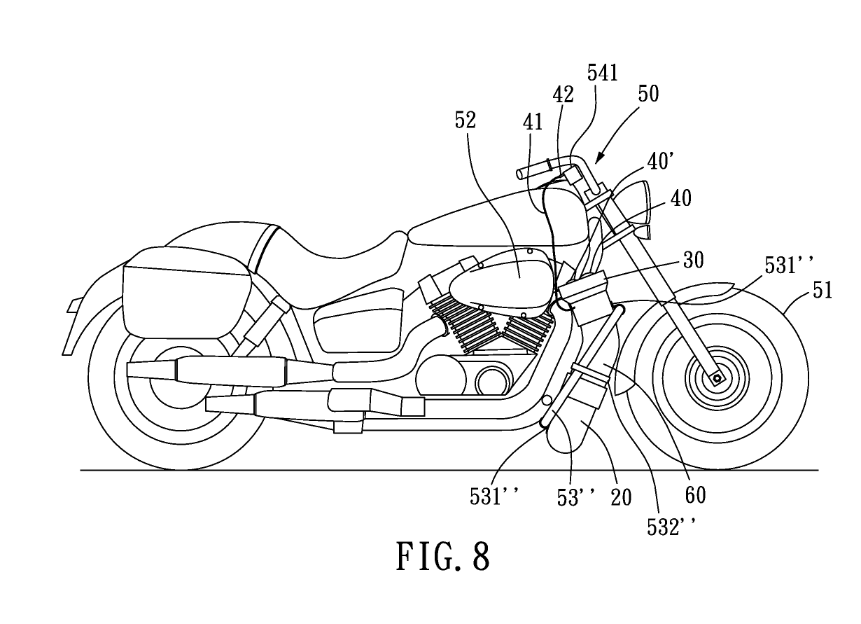

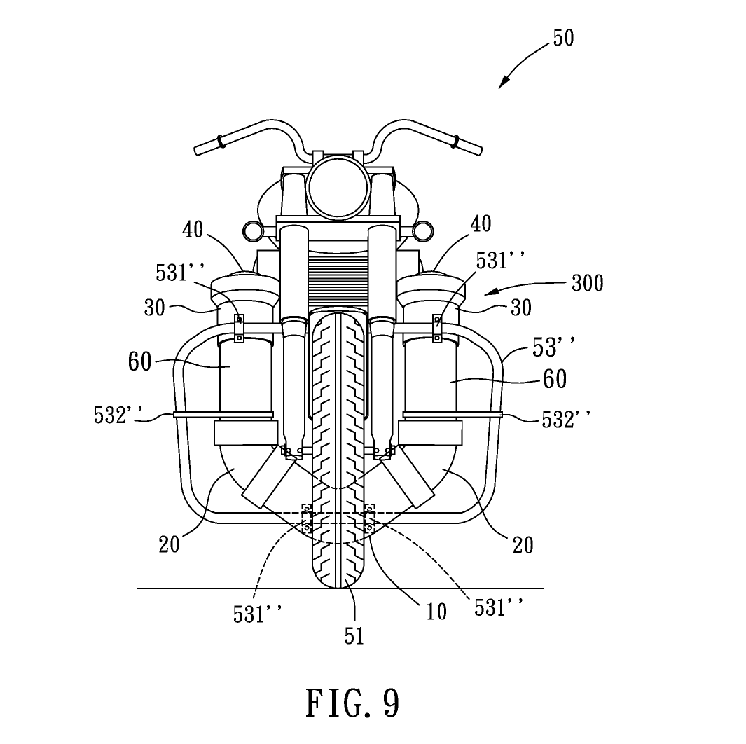

Please refer to FIGS. 7 to 9, in which FIG. 7 is an exploded perspective view of a speaker box structure 300 according to a third embodiment of the present invention, and FIGS. 8 and 9 are side and front views, respectively, showing the speaker box structure 300 mounted on a motorcycle 50.

The speaker box structure 300 in the third embodiment is generally structurally similar to the speaker box structure 100 in the first embodiment, except that, in the third embodiment, the tubular bottom section 10 internally has a reflex tube 13′ larger than the reflex tube 13 in size, the two tubular connection sections 30 further include a tubular redirecting section 60 each, and two additional speaker units 40′ are provided. As the reflex tube 13′ orients to the ground surface, so that the enhanced low frequency sound will be reflected by the ground surface and then reaches the rider. The tubular redirecting sections 60 are connected at their upper ends to the first ends 31 of the two tubular connection sections 30, and at their lower ends to the second ends 22 of the two tubular bent sections 20. With these arrangements, the speaker box structure 300 can be assembled and mounted to the motorcycle 50 according to the configuration and appearance thereof while allowing effective change of the directions to which the speaker units 40, 40′ are directed. The two speaker units 40 and the two speaker units 40′ are grouped into two sets, each of which includes one speaker unit 40 and one speaker unit 40′ that can be, for example, one woofer and one tweeter, respectively. The two sets of speaker units 40, 40′ are mounted to the second ends 32 of the tubular connection sections 30. With this arrangement, the speaker box structure 300 can produce sound quality different from that of the speaker box structure 100. Further, the tubular redirecting sections 60 can be integrally formed with the tubular connection sections 30 or be connected thereto by means of hooking, locking, snap-fitting or the like. Further, the tubular bottom section 10, the tubular bent sections 20 and the tubular connection sections 30 together give the whole speaker box structure 300 a substantially V-shaped configuration.

As can be seen in FIG. 8, with the tubular redirecting sections 60, the speaker units 40, 40′ can be more accurately oriented to the rider's face, enabling the rider to clearly hear the music output via the speaker box structure 300.

Please refer to FIGS. 8 and 9 again. The motorcycle 50 has a protective bar 53″ larger than the protective bar 53 in shape. Therefore, when mounting the speaker box structure 300 to the motorcycle 50, the user may upward extend the tubular connection sections 30 through the spaces defined in the large protective bar 53″. To do so, first lock the tubular connection sections 30 and the tubular bent sections 20 to an upper inner side and a lower outer side of the protective bar 53″, respectively, with a plurality of fastening elements 531″, which can be screws, rivets or the like. Then, hold the tubular redirecting sections 60 to the protective bar 53″ near its middle portion with fastening elements 532″. With these arrangements, the speaker box structure 300 can be more securely mounted to the motorcycle 50.

In brief, the speaker box structure 300 of the present invention can be configured and mounted according to the motorcycle appearance, such as the space size between the front wheel and the engine, the shape and position of the protective bar and the like, and can therefore be additionally mounted on different types of motorcycles, such as cruiser motorcycles. Further, the speaker box structure 300 of the present invention also allows the user to adjust the sizes and angles of the tubular bottom section 10, the tubular bent sections 20, the tubular connection sections 30 and the tubular redirecting sections 60 and to select different types of speaker units 40, 40′ according to the user's actual need. Because the tubular bottom section 10, the tubular bent sections 20, the tubular connection sections 30 and the tubular redirecting sections 60 have simple structure and are made of plastic tubes that are easily to get, the speaker box structure 300 of the present invention can be manufactured at effective way to reduce the cost and assembling time.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A speaker box structure for mounting to a motorcycle between a front wheel and an engine thereof, comprising:
a tubular bottom section having a first end and an opposite second end, and at least one reflex tube; the reflex tube being located in the tubular bottom section between the first end and the second end and orients a ground surface;
two tubular bent sections respectively having a first end and a second end; and the first ends of the two tubular bent sections being respectively connected to the first end and the second end of the tubular bottom section;
two tubular connection sections respectively having a first end and a second end; and the first ends of the two tubular connection sections being respectively connected to the second ends of the two tubular bent sections; and
at least two speaker units being respectively connected to the second ends of the two tubular connection sections;
wherein the reflex tube is sequentially communicable with the tubular bent sections and tubular connection sections.

2. The speaker box structure as claimed in claim 1, wherein the tubular bottom section has two reflex tubes located therein, and is further internally provided with a separating element to isolate the two reflex tubes from each other.

3. The speaker box structure as claimed in claim 1, wherein the tubular bottom section, the tubular bent sections and the tubular connection sections are made of plastic tubes.

4. The speaker box structure as claimed in claim 3, wherein the plastic tubes for making the tubular bottom section, the tubular bent sections and the tubular connection sections are selected from the group consisting of polyvinylchloride (PVC) tubes, acrylonitrile butadiene styrene (ABS) tubes, polyethylene (PE) tubes, fibre-reinforced plastic(FRP) tubes, and poly(methyl methacrylate) tubes (i.e. PMMA tubes).

5. The speaker box structure as claimed in claim 1, wherein the tubular connection sections respectively include a tubular redirecting section located at the second ends of the tubular connection sections, and the speaker units being respectively connected to the two tubular redirecting sections.

6. The speaker box structure as claimed in claim 1, wherein the tubular connection sections respectively include a tubular redirecting section located at the first ends of the tubular connection sections and the tubular redirecting sections respectively connect to the second ends of the tubular bent sections.

7. The speaker box structure as claimed in claim 1, wherein the speaker units are selected from the group consisting of full-range speaker units, tweeters, mid-range speaker units, woofers, and any combination thereof

8. The speaker box structure as claimed in claim 1, wherein the speaker units are four in number, and the second ends of the two tubular connection sections respectively have two of the four speaker units connected thereto.

9. The speaker box structure as claimed in claim 1, wherein the tubular bottom section, the tubular bent sections and the tubular connection sections together give the whole speaker box structure a U-shaped or a V-shaped configuration.

10. The speaker box structure as claimed in claim 1, wherein the tubular bottom section, the tubular bent sections and the tubular connection sections are integrally formed with one another.
